(19) United States
(12) Patent Application Publication
(10) Pub. No.: US 2025/0138483 A1
(43) Pub. Date: May 1, 2025

(54) Dual Counterrotating Bezel Watch Assembly

(71) Applicant: Andrew J. Zayach, Sandy, UT (US)

(72) Inventor: Andrew J. Zayach, Sandy, UT (US)

(21) Appl. No.: 18/932,548

(22) Filed: Oct. 30, 2024

Related U.S. Application Data
(60) Provisional application No. 63/594,399, filed on Oct. 30, 2023.

(51) Int. Cl. G04B 19/28

(52) U.S. Cl. CPC G04B 19/283

(57) ABSTRACT

A dual-bezel watch assembly having two counterrotating bezels, an inner bezel and an outer bezel, the inner bezel having a lower surface comprising a set of regularly-spaced first teeth, and an outer bezel comprising a set of regularly-spaced second teeth. The assembly may comprise a plurality of gaskets, channels and cantilevering flanges.

### BACKGROUND OF THE INVENTION

### Field of the Invention

This invention relates to timepieces, and more particularly relates to a wrist-mounted watch having directional bezels.

### Description of the Related Art

Typically watches in the art may have a bezel; i.e. a ring around the case. Two types of bezels are commonly used; timing bezels and diving bezels. Timing bezels move in both clockwise and counter-clockwise directions while diving bezels, which are used to visually keep track of a diver's air supply by measuring dive time, only rotate in the counter-clockwise direction. Other bezels may be purely aesthetic and may not move in either direction. There exist no watches in the art with efficient dual-bezels incorporated into the design which are functional and water-resistant and quickly accessible.

The present invention provides a watch bezel assembly having dual-bezel that uses a resilient device, such as a spring or bumper or pawl, positioned within a channel formed between the bezels to allow counterrotating function. Current technology in the art does not provide for dual-bezel function.

### SUMMARY OF THE INVENTION

From the foregoing discussion, it should be apparent that a need exists for a counterrotating dual-bezel watch assembly. Beneficially, such an apparatus would overcome many of the difficulties and safety concerns expressed.

The present invention has been developed in response to the problems and needs in the art that have not yet been fully solved or explored by currently available apparati and methods. Accordingly, the present invention has been developed to provide a dual-bezel watch assembly is provided comprising: a case housing a watch face with a raised circular support, the raised circular support comprises a lateral protuberance circumscribing the watch face; an outer bezel positioning exteriorly of an inner bezel, the outer bezel comprising: a top surface; an outer flange descending inferiorly from the declined top surface; outer teeth spaced at regular intervals around an interior surface of the outer flange; the inner bezel positioned within the outer bezel, the inner bezel comprising: a plurality of teeth a regularly-space intervals circumscribing a lower surface of the inner bezel; an annular inner lip positioning above a raised circular support of a case; wherein the case defines: an annular channel circumscribing the watch face, the annular channel dimensioned to receive the inner teeth and of the inner bezel; wherein the case defines a large spring recess circumscribing the watch face annularly, the large spring recess dimensioned to receive a large spring.

The dual-bezel watch assembly may further comprise the small spring having a lever arm.

An outer surface of the inner bezel and an inner surface of the outer bezel may be grooved to form a gasket recess, the gasket recess housing a gasket.

A lever arm recess may dispose beneath the inner teeth dimensioned to receive a lever arm of a small spring.

A second dual-bezel watch assembly is provided comprising: a case, the case housing a watch face; an outer bezel positioning exteriorly of an inner bezel, the outer bezel comprising: a top surface; an outer flange descending inferiorly from the declined top surface; outer teeth spaced at regular intervals around an interior surface of the outer flange; the inner bezel positioned within the outer bezel, the inner bezel comprising: a plurality of teeth a regularly-space intervals circumscribing a lower surface of the inner bezel; an annular inner lip positioning above a raised circular support of a case; wherein the case defines: an annular channel circumscribing the watch face, the annular channel dimensioned to receive the inner teeth and of the inner bezel; wherein the case defines a large spring recess circumscribing the watch face annularly, the large spring recess dimensioned to receive a large spring.

The watch face may position centrically to the outer bezel and inner bezel. The dual-bezel watch assembly may further comprise a gasket disposed between the case and the inner bezel, the gasket circumscribing the watch face.

The dual-bezel watch assembly may further comprise a gasket disposed between the inner bezel and outer bezel, the gasket circumscribing the watch face. The top surface out the outer bezel may be declined.

A third dual-bezel watch assembly is provided comprising: an annular outer bezel comprising a plurality of pawls adapted to engage teeth on an inner bezel; an inner bezel positioned within the outer bezel having an outer surface comprising first teeth at first regularly-spaced intervals adapted to engage the pawls, the inner bezel having a lower surface comprising second teeth at second regularly-spaced intervals.

The dual-bezel watch assembly may consist of first teeth numbering one of 20, 40, 60, 100, 120 and 180. Alternatively, the dual-bezel watch assembly may consist of second teeth numbering one of 20, 40, 60, 100, 120 and 180. The dual-bezel watch assembly may further comprise an inner cantilevering flange adapted to cantilever over a portion of a watch face circumscribing the inner bezel.

An inner edge of the inner bezel may define an inner hemispherical channel into which a first gasket is received. A lower planar surface of the outer bezel may define a lower hemispherical channel adapted to receive a lower gasket. A top surface of the outer bezel may decline toward an outer periphery of the outer bezel.

The inner bezel and outer bezel may counterrotate. The inner bezel and outer bezel may be metered.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates a bottom view of an inner bezel of a dual-bezel watch/bezel assembly in accordance with the present invention;

FIG. 2 illustrates a side view of an outer bezel of a dual-bezel watch/bezel assembly in accordance with the present invention;

FIG. 3 illustrates a bottom view of an outer bezel of a dual-bezel watch/bezel assembly in accordance with the present invention;

FIG. 4 illustrates a sectioned, side view of a case of a dual-bezel watch/bezel assembly in accordance with the present invention;

FIG. 5A illustrates an exploded, sectioned, side view of a dual-bezel watch/bezel assembly in accordance with the present invention;

FIG. 5B illustrates a sectioned, side view of a case of a dual-bezel watch/bezel assembly in accordance with the present invention;

FIG. 5C illustrates a sectioned, side view of a case of a dual-bezel watch/bezel assembly in accordance with the present invention;

FIG. 6A illustrates a side view of a small pin of a dual-bezel watch/bezel assembly in accordance with the present invention;

FIG. 6B illustrates a view of a small pin of a dual-bezel watch/bezel assembly in accordance with the present invention;

FIG. 6C illustrates a top view of a large pin of a dual-bezel watch/bezel assembly in accordance with the present invention;

FIG. 6D illustrates a forward view of a large pin of a dual-bezel watch/bezel assembly in accordance with the present invention;

FIG. 6E illustrates a side view of a large pin of a dual-bezel watch/bezel assembly in accordance with the present invention;

FIG. 6F illustrates a view of a large pin of a dual-bezel watch/bezel assembly in accordance with the present invention;

FIG. 7A illustrates a top view of a register dual-bezel watch/bezel assembly in accordance with the present invention;

FIG. 7B illustrates a top view of a register dual-bezel watch/bezel assembly in accordance with the present invention;

FIG. 8 illustrates a top view of a register dual-bezel watch/bezel assembly in accordance with the present invention;

FIG. 9 illustrates a top view of a register dual-bezel watch/bezel assembly in accordance with the present invention;

FIG. 10 illustrates a top view of a register dual-bezel watch/bezel assembly in accordance with the present invention;

FIG. 11 illustrates a top view of a dual-bezel watch/bezel assembly in accordance with the present invention;

FIG. 12 illustrates a top view of a dual-bezel watch/bezel assembly in accordance with the present invention;

FIG. 13 illustrates a lower view of an inner bezel of a dual-bezel watch assembly in accordance with the present invention;

FIG. 14 illustrates a top view of an inner bezel of a dual-bezel watch assembly in accordance with the present invention;

FIG. 15 illustrates a sectioned view of a dual-bezel watch or bezel assembly in accordance with the present invention;

FIG. 16 illustrates a side view of a dual-bezel watch or bezel assembly in accordance with the present invention;

FIG. 17 illustrates a sectioned, side view of a dual-bezel watch/bezel assembly in accordance with the present invention;

FIG. 18 illustrates a top view of a dual-bezel watch assembly in accordance with the present invention;

FIG. 19 illustrates a side view of a dual-bezel watch assembly in accordance with the present invention;

FIG. 20A illustrates a bezel plate and configuration in accordance with the present invention;

FIG. 20B illustrates a bezel plate and configuration in accordance with the present invention;

FIG. 20C illustrates bezel plate and configuration in accordance with the present invention;

FIG. 20D illustrates a bezel plate and configuration in accordance with the present invention;

FIG. 20E illustrates a bezel plate and configuration in accordance with the present invention;

FIG. 20F illustrates a bezel plate and configuration in accordance with the present invention;

FIG. 20G illustrates a bezel plate and configuration in accordance with the present invention;

FIG. 20H illustrates a bezel plate and configuration in accordance with the present invention;

FIG. 20I illustrates a bezel plate and configuration in accordance with the present invention;

FIG. 20J illustrates a bezel plate and configuration in accordance with the present invention;

FIG. 20K illustrates a bezel plate and configuration in accordance with the present invention;

FIG. 20L illustrates a bezel plate and configuration in accordance with the present invention;

FIG. 20M illustrates a bezel plate and configuration in accordance with the present invention;

FIG. 20N illustrates a bezel configurations in accordance with the present invention;

FIG. 20O illustrates a bezel plate and configuration in accordance with the present invention;

FIG. 20P illustrates a bezel plate and configuration in accordance with the present invention;

FIG. 20Q illustrates a bezel plate and configuration in accordance with the present invention;

FIG. 21A illustrates a bezel configuration in accordance with the present invention;

FIG. 21B illustrates a bezel configuration in accordance with the present invention;

FIG. 21C illustrates a bezel configuration in accordance with the present invention;

FIG. 21D illustrates a bezel configuration in accordance with the present invention;

FIG. 21E illustrates a bezel configuration in accordance with the present invention;

FIG. 21F illustrates a bezel configuration in accordance with the present invention;

FIG. 22 illustrates a plurality of bezel configurations in accordance with the present invention; and

FIG. 23 illustrates a plurality of bezel configurations in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

It is an object of the present invention to provide a watch with dual-bezels.

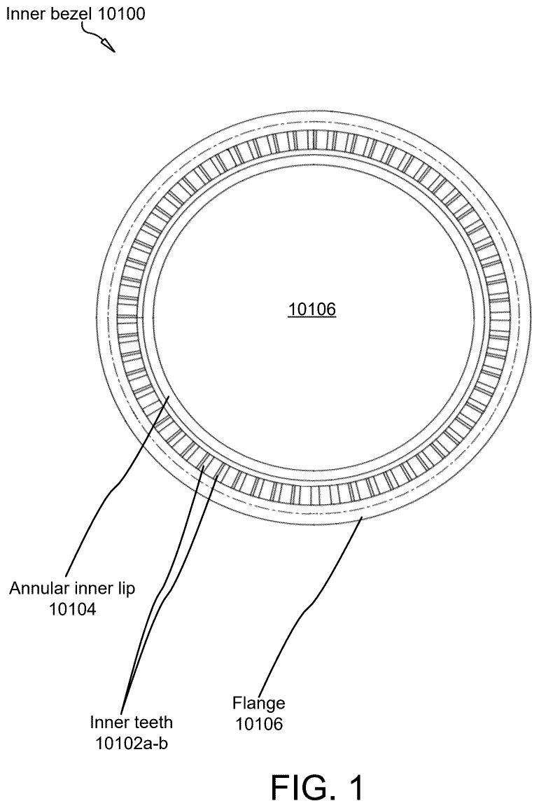

FIG. 1 illustrates a bottom view of an inner bezel of a dual-bezel watch/bezel assembly 10100 in accordance with the present invention.

The bezel assembly 10100 comprises an inner and outer bezel 10100, 10200 respectively. The inner bezel 10100 and the outer bezel 10200 may be axially counterrotating. A watch face disposes within a circular recess 10106 defined by the inner bezel 10100. In some embodiments, the inner bezel 10100 rotates counterclockwise in diametric opposition to the watch hands while the outer bezel 10200 rotates clockwise about the same axis as the hands of the watch.

The inner bezel 10100 comprises a plurality of teeth 10102 spaced at regular intervals around a perimeter of the inner bezel. In the shown embodiment, the inner bezel 10100 comprises 60 teeth, but may comprise 10, 20, 30, 40, 90, 120, or 180 teeth in other embodiments.

An annular lip 10104 circumscribes an interior edge of the inner bezel 10100. The annular lip 10104 cantilevers over the case and is operable to rest upon a raised circular support 10410 of the case 10400. The teeth 10102 position inferiorly to the lower edge of the annular lip 10104.

The flange 10106 circumscribes the exterior perimeter of the inner bezel 10100. The flange 10106 comprises a cylindrical sidewall jutting inferiorly below the teeth 10102.

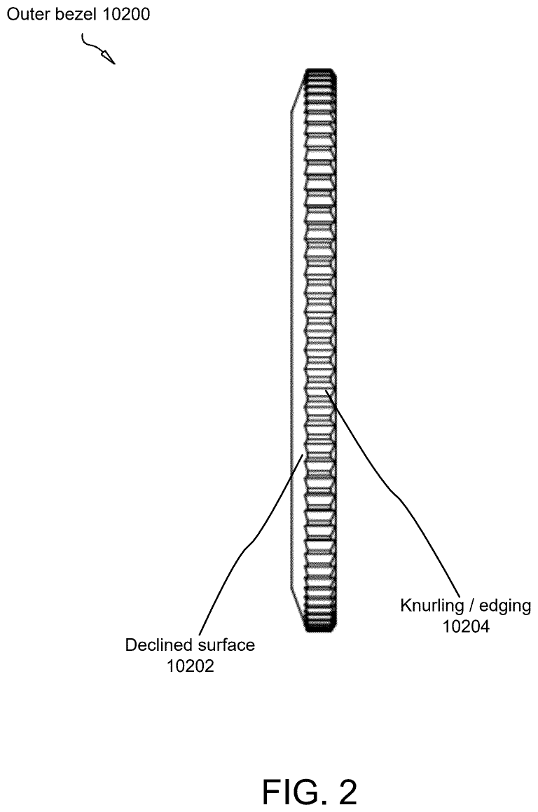

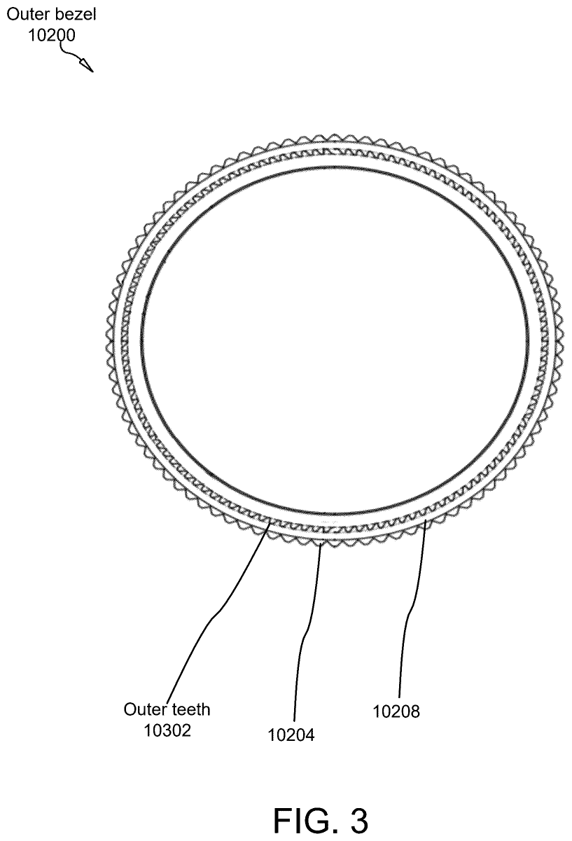

FIGS. 2-3 illustrate a views of an outer bezel 10200 of a dual-bezel watch/bezel assembly in accordance with the present invention.

The top surface of the outer bezel 10200 may be declined toward the exterior edge. The outer bezel 10200 comprises a declined top surface 10202.

The outer edge of the outer bezel 10300 may comprise knurling 10204 or otherwise comprise texturing or surfacing operable to improve grip by a user of the outer bezel 10200. Other surfacing may include ridges or grooves running vertically and spaced at regular intervals around the perimeter of the outer bezel 10200.

The outer bezel 10200 may comprise an outer flange 10208 descending inferiorly from an outer perimeter of the outer bezel 10200. The knurling 10204 may affix, or be formed as a single integrated piece, with the outer flange 10208.

The outer bezel 10200 comprises a plurality of teeth 10302 spaced at regular intervals on the outer bezel 10200. In the shown embodiment, the outer bezel 10200 comprises 60 teeth, but may comprise 10, 20, 30, 40, 90, 120, or 180 teeth in other embodiments.

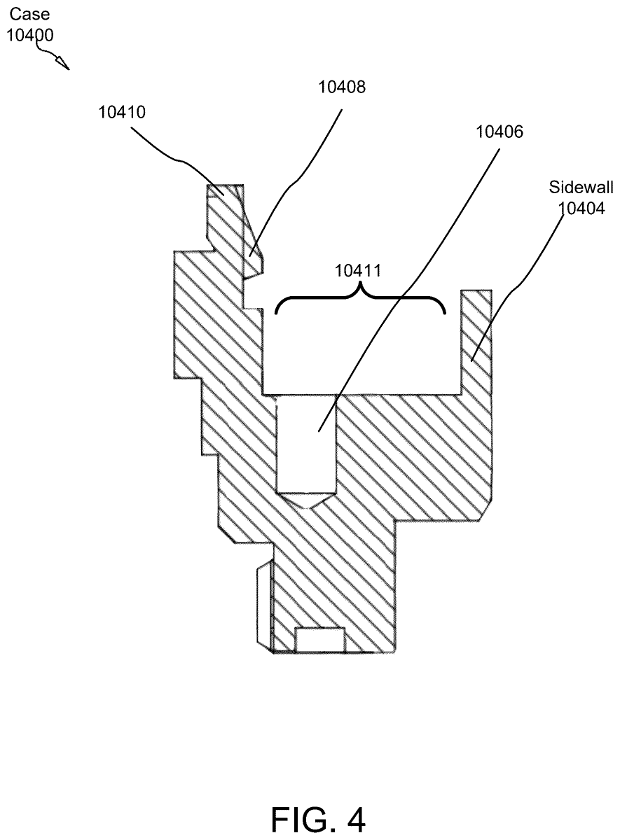

FIG. 4 illustrates a sectioned, side view of a case of a dual-bezel watch/bezel assembly 10400 in accordance with the present invention.

The case 10502 comprises an annular channel 10411 circumscribing the watch face 10106. This channel 10411 is dimensioned to receive the inner teeth 10102 and flange 10106 of the inner bezel 10100.

The lower, inner surface of the channel 10411 defines a large spring recess 10406. A spring, or large pin, 10700 positions within the large spring recess 10406. The spring 10600 may comprise a lever arm 10602 which positions within a lever arm recess 10502 beneath the inner teeth 10102 of the inner bezel 10100 in the assembled watch 10500.

In various embodiments, the case 10400 comprises a raised circular support 10410 which spaces the crystal face of the watch away from the inner bezel 10100. The raised circular support 10410 affixes to, or is formed as a single integrated piece with, a lateral protuberance 10408 circumscribing the raised circular support 10410.

In an assembled configuration, a tension spring recess (i.e., gasket recess 10510) is defined below the lateral protuberance 10408 in which a tension spring and/or gasket is received.

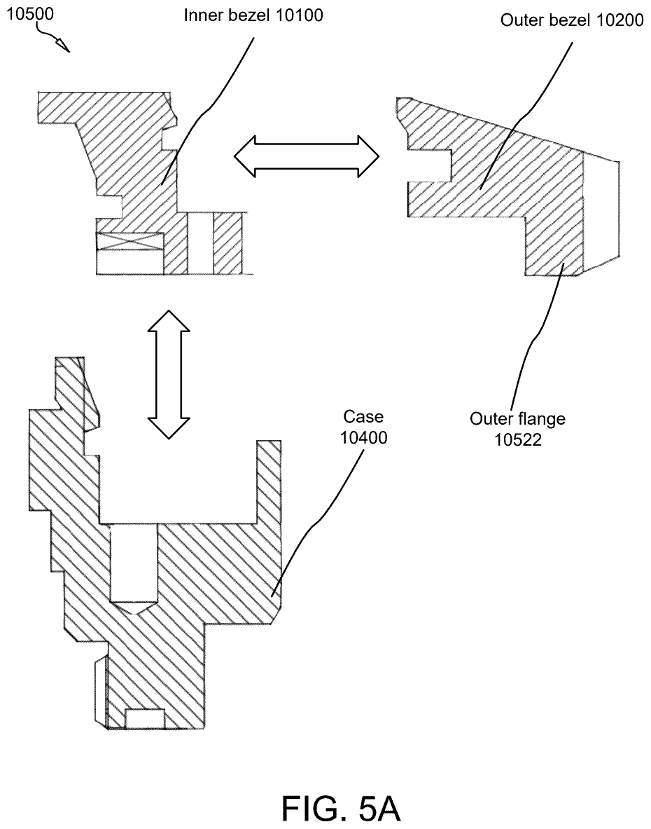

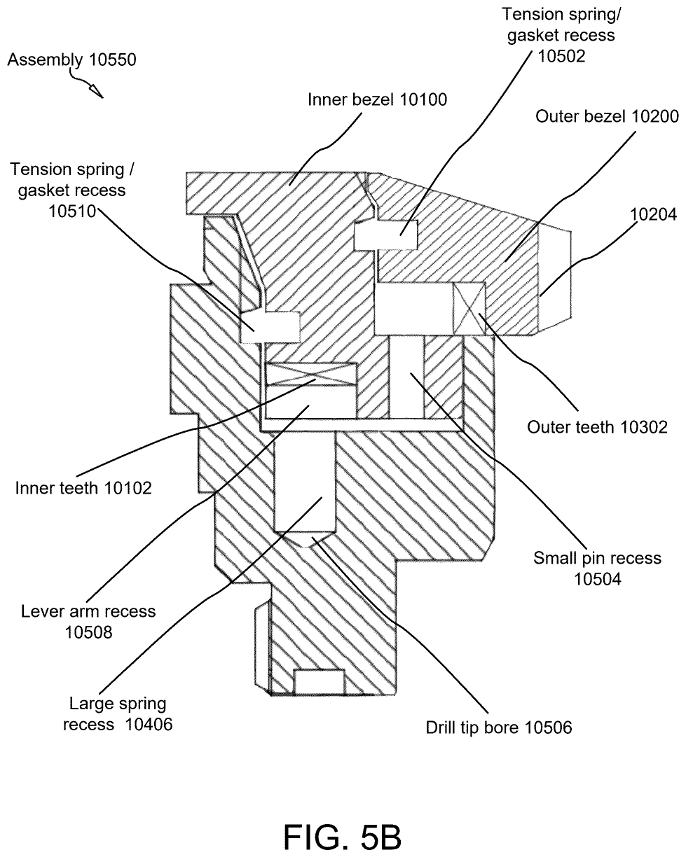

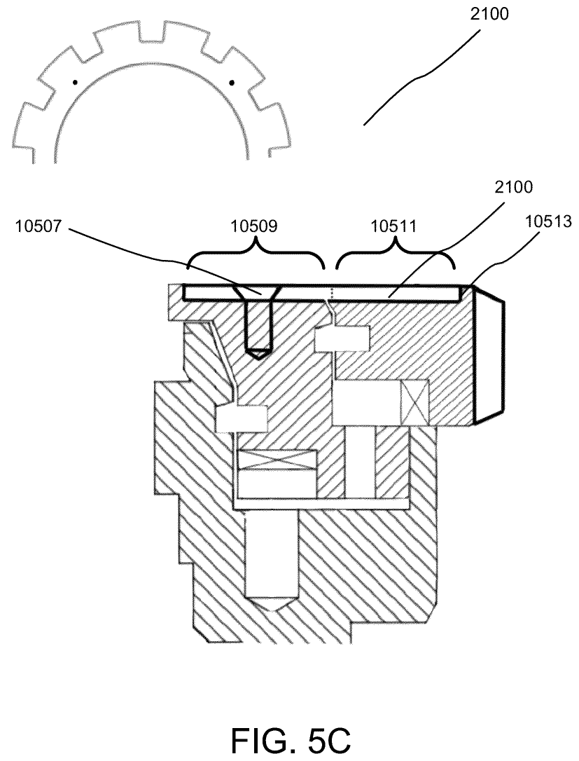

FIGS. 5A-5B illustrate an exploded, sectioned, side view of a dual-bezel watch/bezel assembly 10500, 10550 in accordance with the present invention.

The case 10400, the inner bezel 10100 and the outer bezel 10200 are adapted to mate together as shown.

The outer edge of the inner bezel 10100 and the inner edge of the outer bezel 10200 each defines tracks, or channels, together forming a second tension spring recess 10502, or gasket recess 10502.

A lever arm recess 10508 forms below the inner teeth 10102 in the assembled configuration 10550 in which a classic click spring inserts.

A drill tip bore 10506 may dispose below the large spring recess 10406.

FIG. 5C illustrates a sectioned, side view of a case of a dual-bezel watch/bezel assembly in accordance with the present invention.

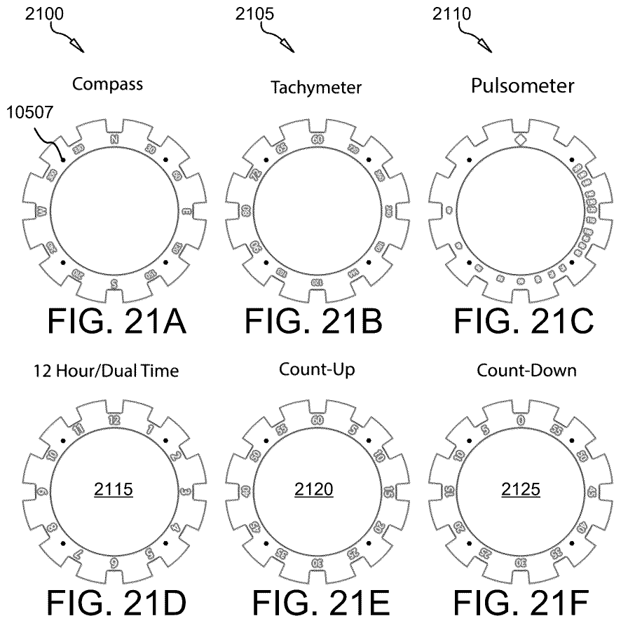

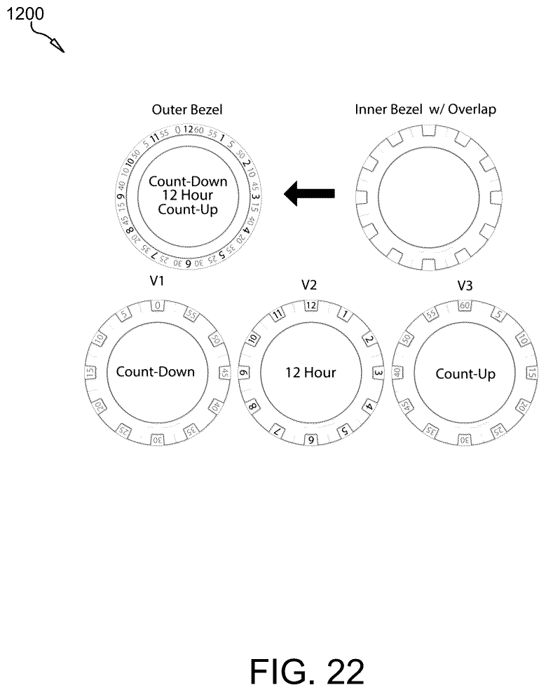

In some embodiments, a top surface of the inner and/or outer bezels are recessed to provide a track or channel into which one of the bezel plates shown in FIGS. 21A-22 may be placed, such as bezel 2100, 2105, 2110, etc.

The bezel plate 2110 may be inserted in the recess 10513. The bezel plate 2100 may be held down with a screw 10507.

In various embodiments, a separate bezel plate 1509 positions over the inner bezel from the bezel plate 15011 which positions over the outer bezel.

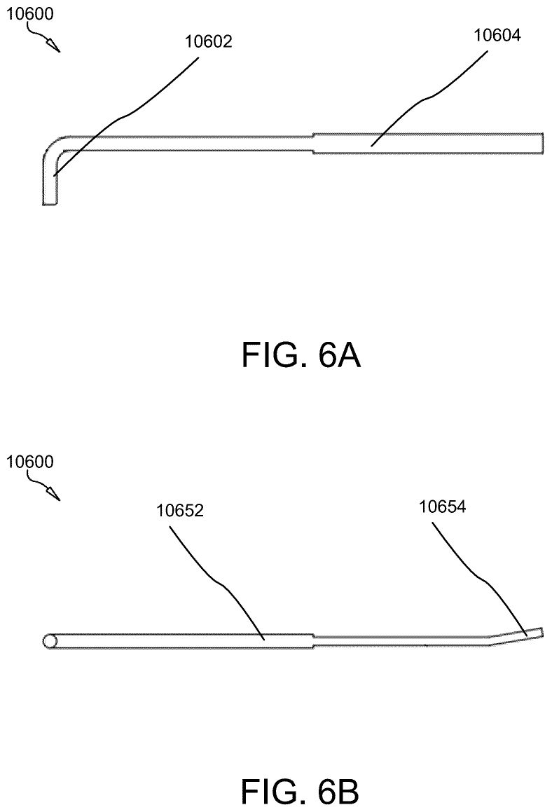

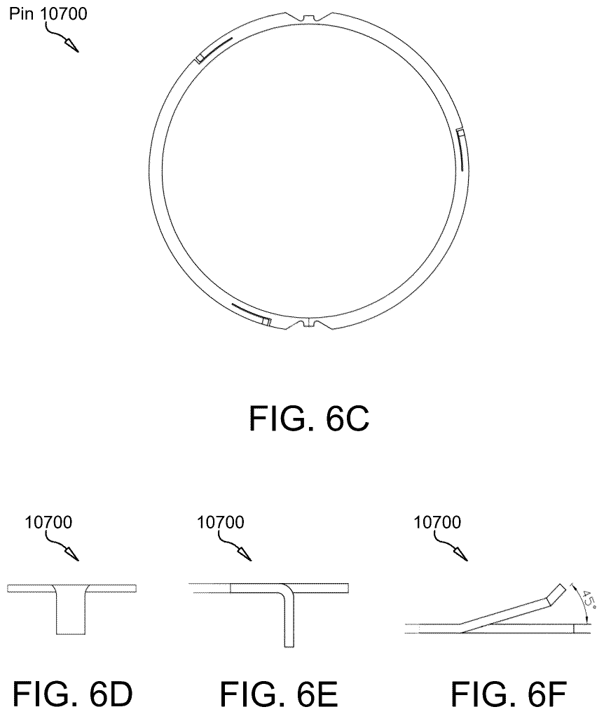

FIG. 6A illustrates a side view of a small pin 10600 of a dual-bezel watch/bezel assembly in accordance with the present invention.

The small pin 10600 inserts into the small pin recess 10504 with the lever arm 10602 oriented so as to engage the outer teeth 10302. The lever arm 10602 may angle away from the main body 10604 of the small pin 10600 at a 90 degree angle, or alternatively between 0 and 90 degrees or 0 and 120 degrees.

FIG. 6B illustrates a view of a small pin 10600 of a dual-bezel watch/bezel assembly in accordance with the present invention.

The pin 10600 may comprise an angled tip 10654 which angles away from the main body 10652 of the large pin 10600. The main body 10652 may be cylindrical. The large pin 10700 positions within the large spring recess 10406 in the assembled watch.

FIGS. 6C-6F illustrates a views of a large pin 10700 of a dual-bezel watch/bezel assembly in accordance with the present invention;

The large pin 10700 inserts into the large spring recess 10406.

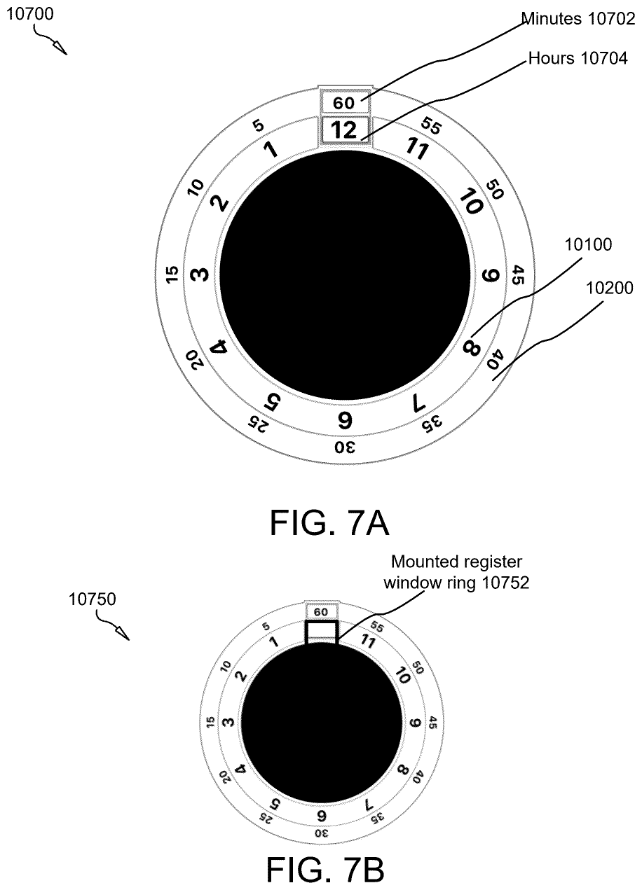

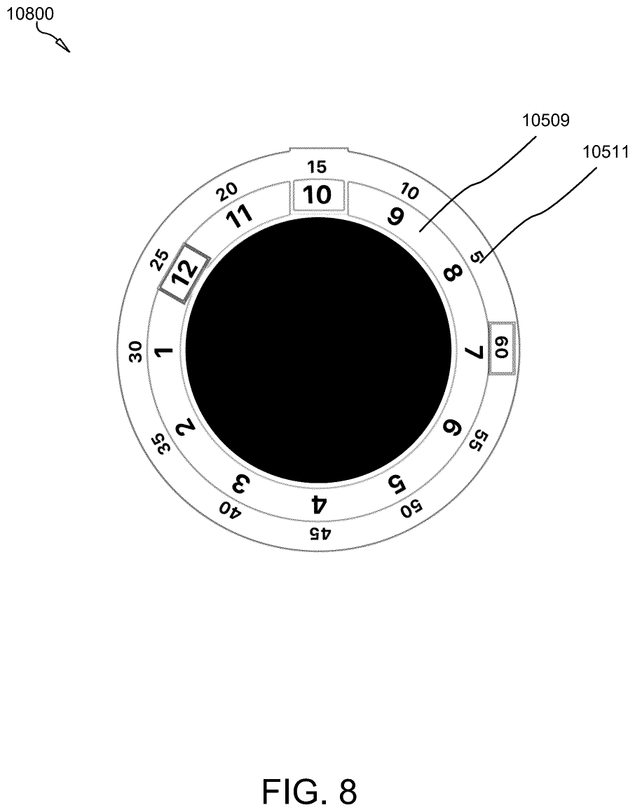

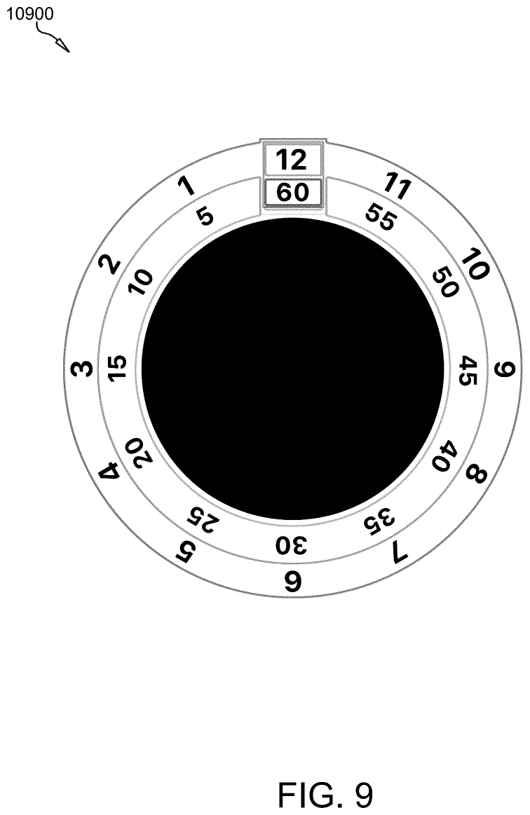

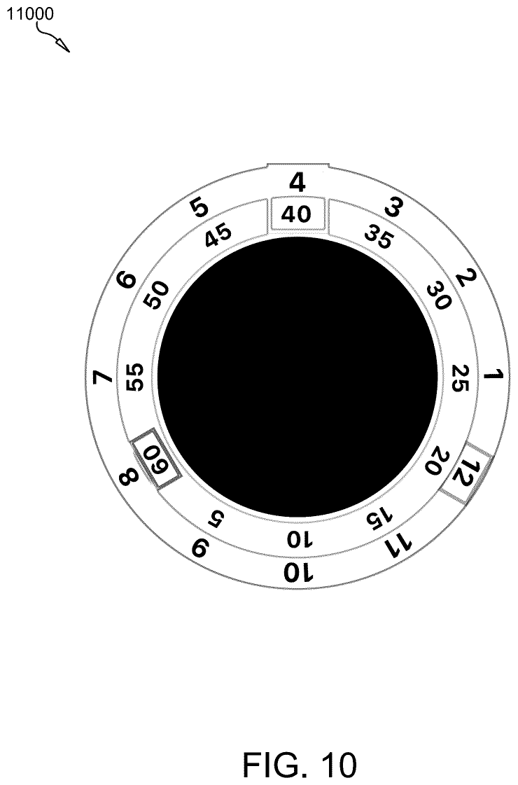

FIGS. 7-10 illustrate top views of a register 10700 of a dual-bezel watch/bezel assembly in accordance with the present invention.

The outer bezel 10200 may comprise a minute indicator 10702, or metering exclusively associated with minutes, while the inner bezel 10100 may comprise an hour meter 10704 exclusively associated with hours.

FIG. 7B illustrates a top view of a register dual-bezel watch/bezel assembly in accordance with the present invention.

The mounted register window ring 10752 affixes to the raised circular support of the case. It provides an aperture overhanging one or more of the inner bezel 10100 and outer bezel 10200 through which a meter on the inner or outer bezel may be viewed. The mounted register window ring 10752 is generally affixed in the twelve o′clock position.

Together, these indicators 10702, 10704 may be rotated to set . . .

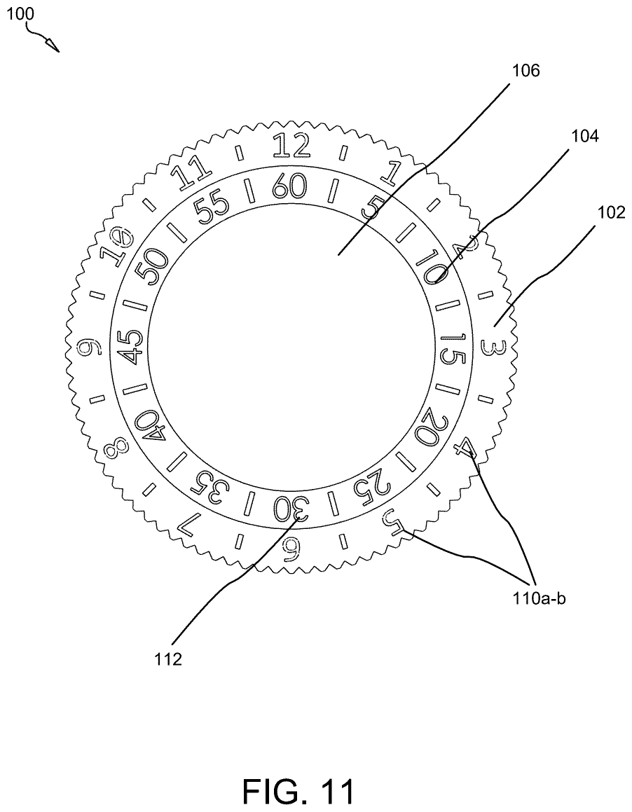

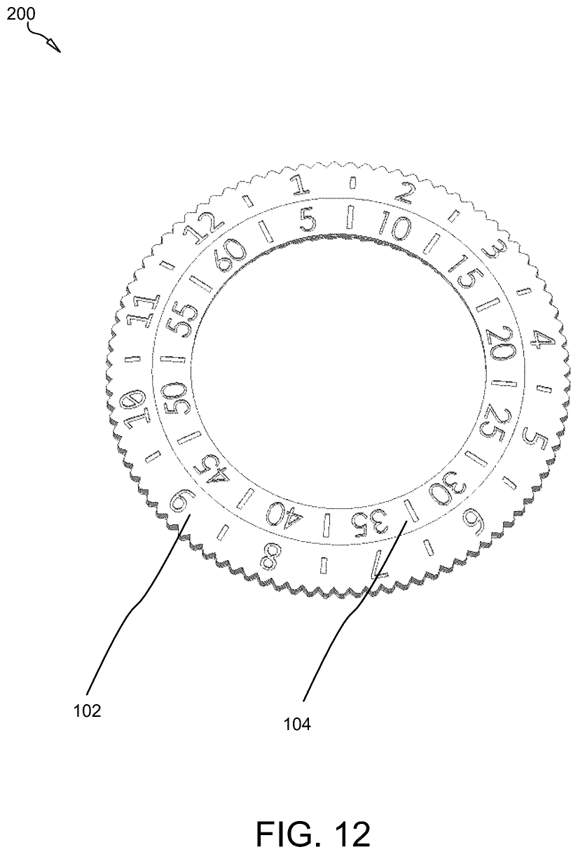

FIGS. 11-12 illustrate top views of a dual-bezel watch/bezel assembly 100, 200 in accordance with the present invention.

The bezel assembly 100 comprises an inner and outer bezel 104, 102 respectively. The inner bezel 104 and the outer bezel 102 may be axially counterrotating. The watch face 702 disposes within a circular recess 106 defined by the inner bezel 104. In some embodiments, the inner bezel 104 rotates counterclockwise in diametric opposition to the watch hands while the outer bezel 102 rotates clockwise about the same axis as the hands of the watch.

In various embodiments, the inner bezel 104 and the outer bezel 102 are metered, having indications 112 representing elapsed time, direction, calendar days, cycles of the moon, dive depths, pressure, and the like.

The outer bezel/dial 102 may marked or metered with indicators 110 while the inner bezel 104 may be marked with indicators 112.

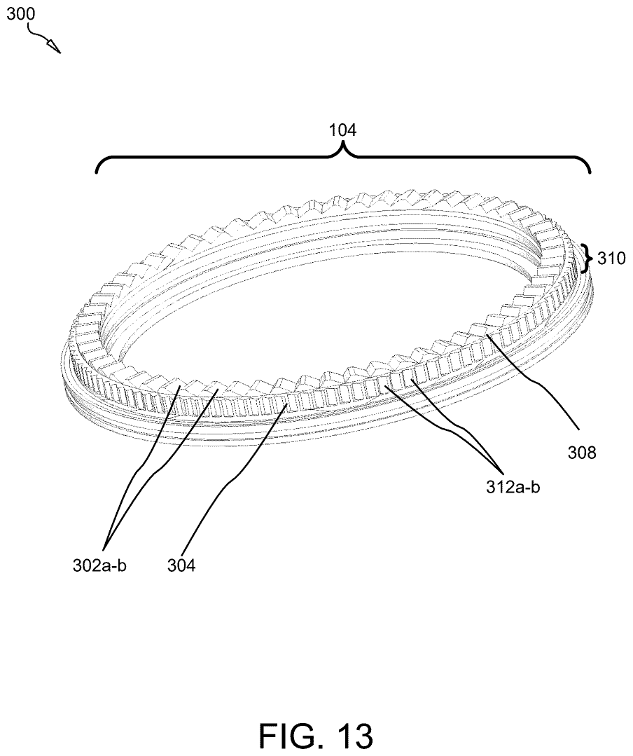

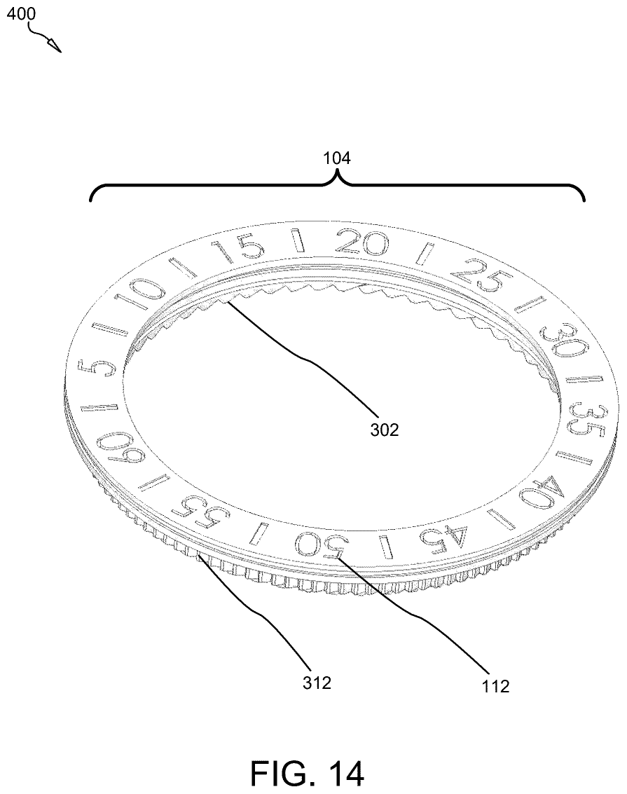

FIGS. 13-14 illustrate perspective view of an inner bezel 104 of a dual-bezel watch assembly 300, 400 in accordance with the present invention.

A lower edge 308 of the bezel 104 may have teeth 302 spaced at regular intervals surrounding the circumference of the lower edge 308. The lower edge 308 may comprise 20, 30, 50, 60, 100, 120, or 180 teeth.

A lateral edge 310 of the bezel 104 may have teeth 312a-b spaced at regular intervals surrounding the circumference of the outer (or inner) lateral edge 310. The lateral edge 310 may comprise 20, 30, 50, 60, 100, 120, or 180 teeth. In various embodiments, the number of teeth on the lateral edge 310 differs from the number of teeth on the lower edge 308 such that fractional distances between teeth may be achieved by operating the bezels/dials 102, 104 in unison.

The inner bezel 104 positions within the annular recess defined by the outer bezel 102. The inner bezel 104 and the outer bezel 102 may form a friction fit, snap fit, or otherwise join using means known to those of skill in the art.

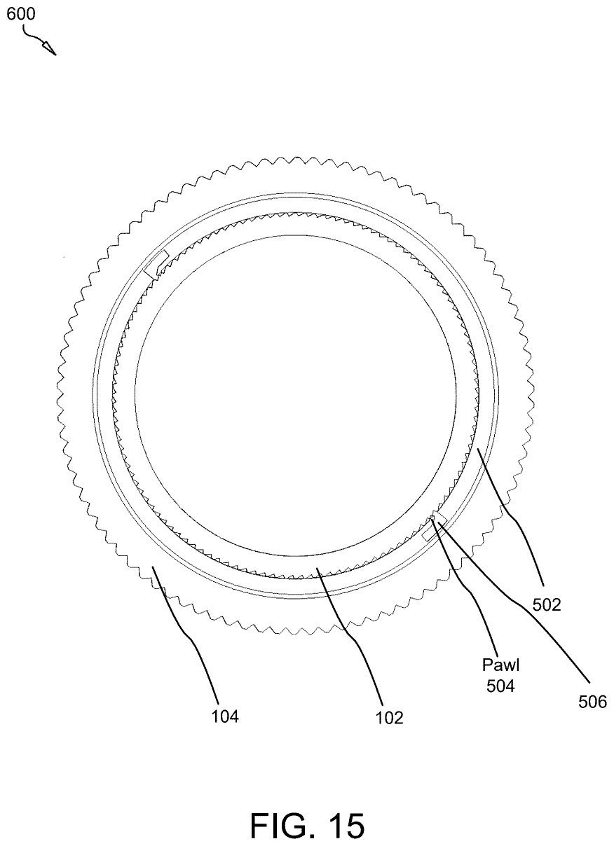

FIG. 15 illustrates a sectioned view of a dual-bezel watch or bezel assembly 500 in accordance with the present invention.

In various embodiments, a lower edge 502 of the outer bezel 104 in cut, engraved, notched or otherwise manipulated to create a protuberance/pawl 504, or a plurality of pawls 504. Each pawl 504 has a recess 506 behind it to facilitate rearward movement of the pawl 504 when teeth 312 move against the pawl 504.

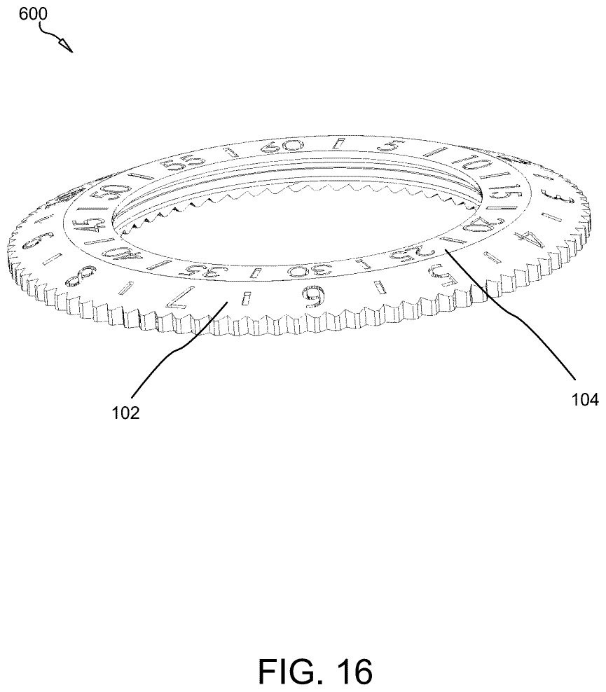

FIG. 16 illustrates a side view of a dual-bezel watch or bezel assembly in accordance with the present invention.

As shown.

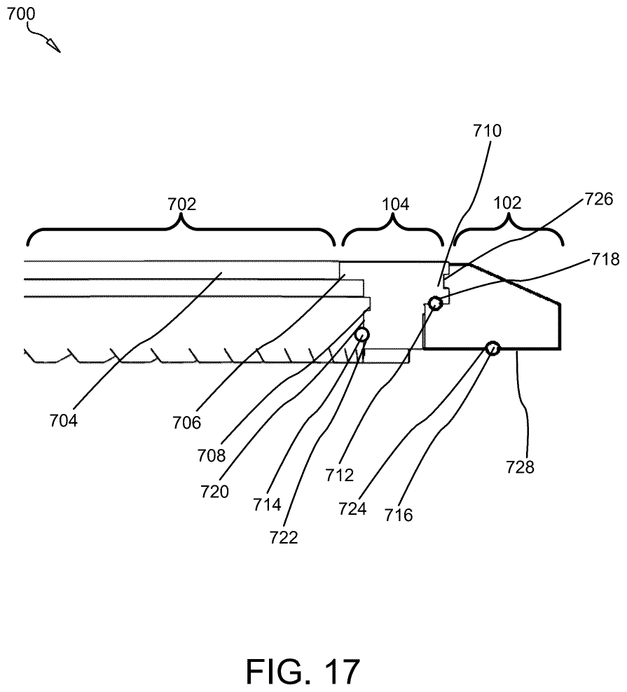

FIG. 17 illustrates a sectioned, side view of a dual-bezel watch/bezel assembly 700 in accordance with the present invention.

The watch face 702 positions between the inner bezel 104 and the outer bezel 102. The crystal 704 of the watch face may be flush with a top surface of the inner bezel 104.

The various embodiments, the inner bezel 104 comprises an inner cantilevering flange 706 which cantilevers over a portion of the watch face 702 and with circumscribes the inner bezel 104.

The inner bezel 104 may define an annular inner track 708 which circumscribes the inner bezel 104.

In various embodiments, the inner bezel 104 comprises an outer cantilevering flange 710 which extends laterally around the perimeter of the inner bezel 104

A lower edge of the outer cantilevering flange 710 may define a hemispherical notch or channel 718 adapted to secure and retain a gasket 712, which gasket 712 serves to impart water-tight, water-resistant or water-proof function to the assembly 700.

An inner edge 720 of the inner bezel 104 may define an inner hemispherical channel 722 in which a gasket 714 is received. The gasket 714 may be formed from polymeric materials and forms an uninterrupted annular band.

A lower planar surface 728 of the outer bezel 102 may also define a lower hemispherical channel 724 adapted to receive a lower gasket 716.

A top surface of the outer bezel 102 may taper or decline toward an outer periphery of the outer bezel 102. In various embodiments, an inner edge of the outer bezel 102 comprises a protuberance 726 circumscribing the inner edge.

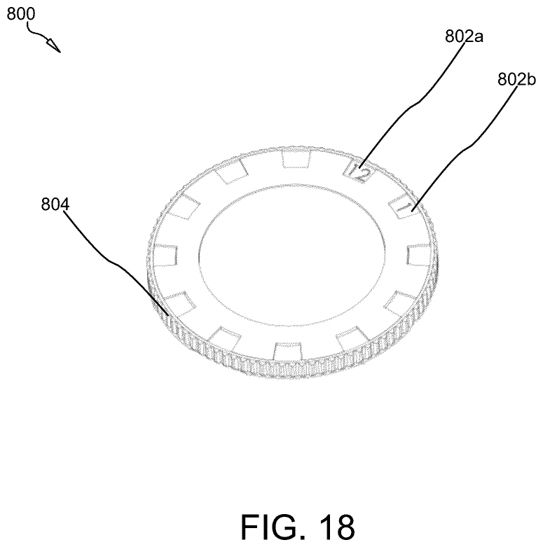

FIG. 18 illustrates a top view of a dual-bezel watch assembly 800 in accordance with the present invention.

The watch assembly 800 comprises at 802a a . . .

FIG. 19 illustrates a side view of a dual-bezel watch assembly 900 in accordance with the present invention.

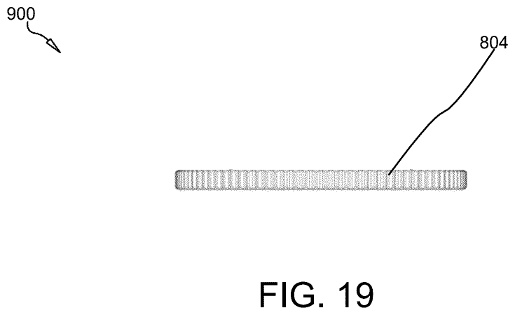

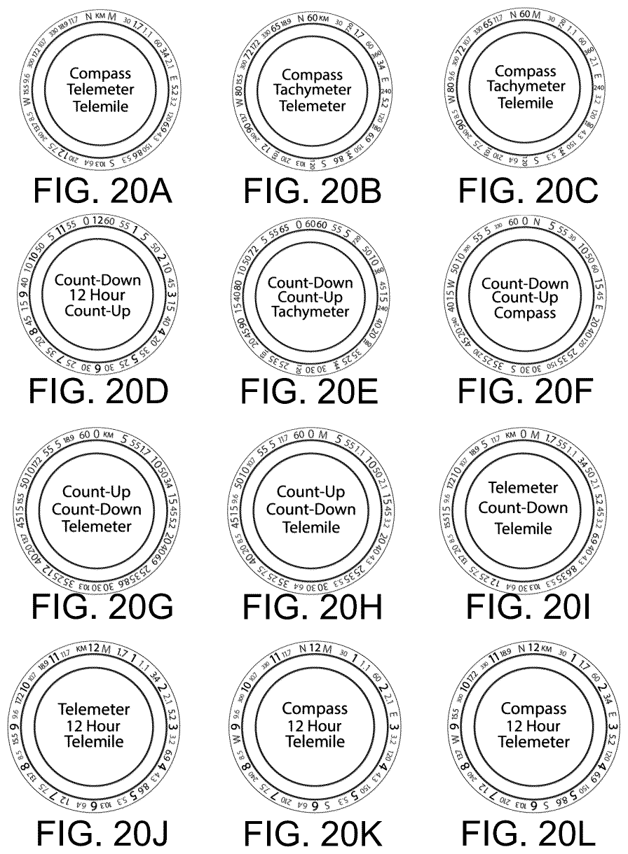

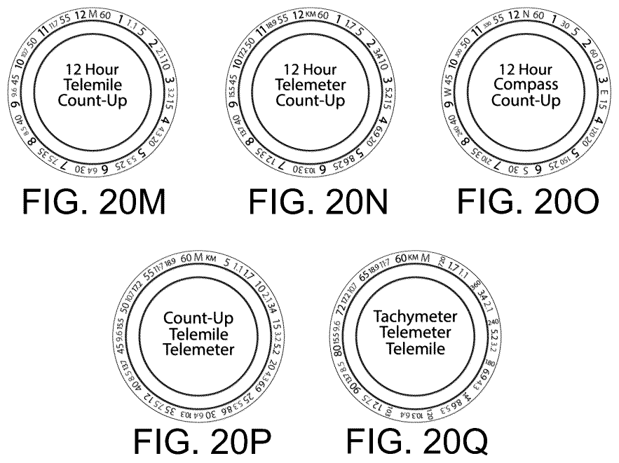

FIGS. 20A-20Q illustrate a plurality of bezel plates and configurations in accordance with the present invention.

FIG. 20A illustrates a compass telemeter telemile.

FIG. 20B illustrates a compass tachymeter telemeter.

FIG. 20C illustrates a compass tachymeter telemile.

FIG. 20D illustrates a count-down 12 hours count-up.

FIG. 20E illustrates a count-down count-up tachymeter.

FIG. 2OF illustrates a count-down count-up compass.

FIG. 20G illustrates a count-up count-down telemeter.

FIG. 20H illustrates a count-up count-down telemile.

FIG. 20I illustrates a telemeter counter-down telemile.

FIG. 20J illustrates a telemeter 12 hours telemile.

FIG. 20K illustrates a compass 12 hour telemile.

FIG. 20L illustrates a compass 12 telemeter.

FIG. 20M illustrates a 12 hour telemile count-up.

FIG. 20N illustrates a 12 hour telemeter count-up.

FIG. 20O illustrates a 12 hour compass count-up.

FIG. 20P illustrates a count-up telemile telemeter.

FIG. 20Q illustrates a tachymeter telemeter telemile.

FIG. 21A illustrates a compass bezel configuration 2100 in accordance with the present invention.

FIG. 21B illustrates a tachymeter bezel configuration 2105 in accordance with the present invention.

FIG. 21C illustrates a pulsometer bezel configuration 2110 in accordance with the present invention.

FIG. 21D illustrates a 12 hour/dual time bezel configuration 2115 in accordance with the present invention.

FIG. 21E illustrates a count-up bezel configuration 2120 in accordance with the present invention.

FIG. 21F illustrates a count-down bezel configuration 2125 in accordance with the present invention;

FIG. 22 illustrates a plurality 1200 of bezel configurations in accordance with the present invention.

In various embodiments, every three click (120 teeth) in the counter-rotating direction of the inner bezel will change the number set within the viewing window under the bezel plate. After the second set of numbers, four clicks will reset back to the first set of number (10 total clicks per three sets, then it repeats).

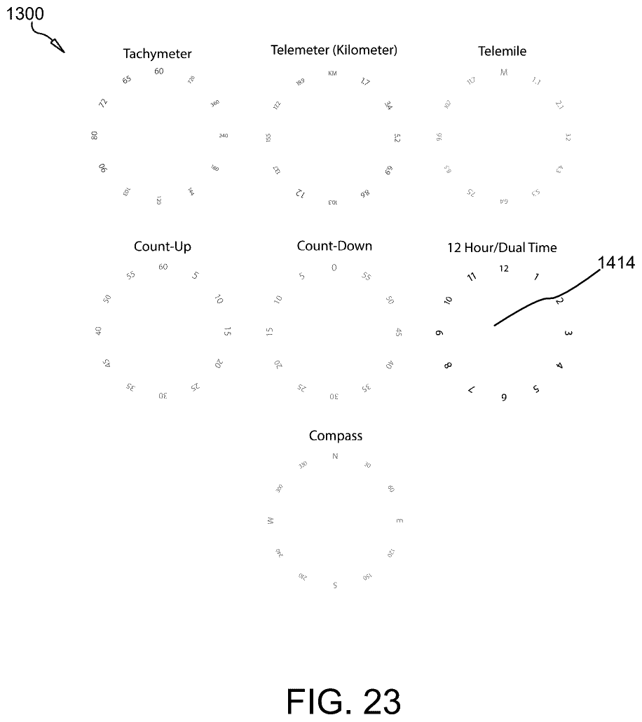

FIG. 23 illustrates a plurality 1300 of bezel configurations in accordance with the present invention.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A dual-bezel watch assembly comprising:
an annular outer bezel comprising a plurality of pawls adapted to engage teeth on an inner bezel;
an inner bezel positioned within the outer bezel having an outer surface comprising first teeth at first regularly-spaced intervals adapted to engage the pawls, the inner bezel having a lower surface comprising second teeth at second regularly-spaced intervals.

2. The dual-bezel watch assembly of claim 1, consisting of first teeth numbering one of 20, 40, 60, 100, 120 and 180.

3. The dual-bezel watch assembly of claim 1, consisting of second teeth numbering one of 20, 40, 60, 100, 120 and 180.

4. The dual-bezel watch assembly of claim 1, further comprising an inner cantilevering flange adapted to cantilever over a portion of a watch face circumscribing the inner bezel.

5. The dual-bezel watch assembly of claim 1, wherein an inner edge of the inner bezel defines an inner hemispherical channel into which a first gasket is received.

6. The dual-bezel watch assembly of claim 1, wherein a lower planar surface of the outer bezel defines a lower hemispherical channel adapted to receive a lower gasket.

7. The dual-bezel watch assembly of claim 1, wherein a top surface of the outer bezel declines toward an outer periphery of the outer bezel.

8. The dual-bezel watch assembly of claim 1, wherein the inner bezel and outer bezel counterrotate.

9. The dual-bezel watch assembly of claim 1, wherein the inner bezel and outer bezel are metered.

10. A dual-bezel watch assembly comprising:
a case housing a watch face with a raised circular support, the raised circular support comprises a lateral protuberance circumscribing the watch face;
an outer bezel positioning exteriorly of an inner bezel, the outer bezel comprising:
a top surface;
an outer flange descending inferiorly from the declined top surface;
outer teeth spaced at regular intervals around an interior surface of the outer flange;
the inner bezel positioned within the outer bezel, the inner bezel comprising:
a plurality of teeth a regularly-space intervals circumscribing a lower surface of the inner bezel;
an annular inner lip positioning above a raised circular support of a case;
wherein the case defines: an annular channel circumscribing the watch face, the annular channel dimensioned to receive the inner teeth and of the inner bezel;
wherein the case defines a large spring recess circumscribing the watch face annularly, the large spring recess dimensioned to receive a large spring.

11. The dual-bezel watch assembly of claim 10, wherein the inner bezel and outer bezel are metered.

12. The dual-bezel watch assembly of claim 10, further comprising the small spring having a lever arm.

13. The dual-bezel watch assembly of claim 10, wherein an outer surface of the inner bezel and an inner surface of the outer bezel are grooved to form a gasket recess, the gasket recess housing a gasket.

14. The dual-bezel watch assembly of claim 10, wherein a lever arm recess disposes beneath the inner teeth dimensioned to receive a lever arm of a small spring.

15. A dual-bezel watch assembly comprising:
a case, the case housing a watch face;
an outer bezel positioning exteriorly of an inner bezel, the outer bezel comprising:
a top surface;
an outer flange descending inferiorly from the declined top surface;
outer teeth spaced at regular intervals around an interior surface of the outer flange;
the inner bezel positioned within the outer bezel, the inner bezel comprising:
a plurality of teeth a regularly-space intervals circumscribing a lower surface of the inner bezel;
an annular inner lip positioning above a raised circular support of a case;
wherein the case defines: an annular channel circumscribing the watch face, the annular channel dimensioned to receive the inner teeth and of the inner bezel;
wherein the case defines a large spring recess circumscribing the watch face annularly, the large spring recess dimensioned to receive a large spring.

16. The dual-bezel watch assembly of claim 15, wherein the watch face positions centrically to the outer bezel and inner bezel.

17. The dual-bezel watch assembly of claim 15, further comprising a gasket disposed between the case and the inner bezel, the gasket circumscribing the watch face.

18. The dual-bezel watch assembly of claim 15, further comprising a gasket disposed between the inner bezel and outer bezel, the gasket circumscribing the watch face.

19. The dual-bezel watch assembly of claim 15, wherein the top surface of the outer bezel is declined.
